(19) United States
(12) Patent Application Publication
(10) Pub. No.: US 2006/0091703 A1
(43) Pub. Date: May 4, 2006

(54) Roof assembly for a vehicle

(75) Inventor: Johannes Nicolaas Huijer, Zandvoort (NL)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Inalfa Aftermarket Group B.V., Venray (NL)

(21) Appl. No.: 11/263,566

(22) Filed: Oct. 31, 2005

(30) Foreign Application Priority Data
Oct. 28, 2004 (NL) NL 1027367

(51) Int. Cl. B60J 7/047

(52) U.S. Cl. 296/220.01

(57) ABSTRACT

An aftermarket roof assembly for a vehicle comprises a frame which includes a trim ring having a passage opening and being adapted to be mounted in the roof opening in the roof skin from above. A main frame part carries longitudinal guide sections on either side of the roof opening, a drain channel assembly and drains act to drain off any water collected in the drain channel assembly. The main frame part is adapted to be mounted to the fixed roof from below. The roof assembly comprises first and second closure panels. The second panel is supported by the trim ring and is positioned behind the first element when the elements are in their closed position. The first panel is moveable by means of the longitudinal guide sections at least between a closed position closing the passage opening and an open position in which it is slid under the second panel and opens the passage opening. Screen assemblies are provided to cover the panels from the interior of the vehicle.

### BACKGROUND OF THE INVENTION

The invention relates to roof assembly for a vehicle having a roof opening in its fixed roof skin and in particularly the invention relates to a roof assembly which is a so called aftermarket roof which is built into the vehicle after the vehicle has been completely manufactured.

A difference between the aftermarket roof system and a roof system that is built in a vehicle during manufacture thereof (a so called OEM roof) is that the latter roof system is especially made for a particular type of vehicle so that is precisely fits to the fixed roof thereof. Aftermarket roof systems should fit into many different types of vehicles with different roof shapes and sizes.

Another difference between aftermarket roof systems and OEM roof systems is that the production number of aftermarket roofs is generally smaller so that investments in a new type of aftermarket roof should be kept to a minimum in order to be able to keep the price competitive.

In the last few years, large roof systems or panorama roof systems have become increasingly popular especially in OEM roof systems. Panorama roofs are characterised by having several closure elements, especially glass panels. In OEM roofs several configurations are known, in which one or more panels can slide below or above each other.

Among the “panorama” aftermarket roofs, two configurations are known. One configuration is a combination of two existing spoiler roofs positioned one behind the other with an intermediate fixed panel in between. Another known aftermarket roof system is a panorama OEM roof system which is adapted in order to be used as an aftermarket roof system.

The first described roof system has the disadvantage that it remains a combination of two separate roofs leading to the use of two passage openings in the vehicle interior. Consequently it is not a real panorama roof having a large interior opening. Furthermore, the spoiler roof can clear only a relatively small part of the roof opening, while the use of two spoiler roofs is costly.

The latter roof system does offer a larger interior opening and a large opening when the roof is in the open position. However, OEM roof systems that can be adapted for use as an aftermarket system is a roof that is mounted “on” the roof skin of the vehicle. As a consequence, the roof significantly projects upwardly from the vehicle roof skin and therefore affects the appearance of the vehicle. This also leads to wind noise. Also the fact that the roof is originally built for one type of vehicle, makes it unsuited to fit into the roof skin of many different types of vehicles.

### SUMMARY OF THE INVENTION

Without limitation one object of the present invention provides an aftermarket roof system in which the disadvantages of the prior art roofs are removed in an effective way.

To obtain this object, an aspect of the invention provides a roof assembly for a vehicle having a roof opening in its fixed roof skin, comprising:
a frame which includes a trim ring having a passage opening and being adapted to be mounted in the roof opening in the roof skin from above, and a main frame part carrying longitudinal guide sections on either side of the roof opening and a drain channel assembly and drains to drain off any water collected in the drain channel assembly, said main frame part being adapted to be mounted to the fixed roof from below,
at least first and second closure elements, the second closure element being supported by the trim ring and being positioned behind the first closure element when the closure elements are in their closed position, the first closure element being moveable by means of said longitudinal guide sections at least between a closed position closing the passage opening and an open position in which it is slid under the second closure element and at least partially opening the passage opening.

The roof assembly is based on the well known sliding or tilt-sliding roof in which the closure element or panel can slide rearwardly below the fixed roof in order to open the roof opening to a large extent. Wind noise can be kept low in this type of roof. The water management system is provided in the main frame part which is mounted below the fixed roof. Also the guide rails for the movable closure elements are provided in the main frame part below the fixed roof, so that it is possible to keep the part projecting above the vehicle roof skin to a minimum. In one embodiment, at least a second closure element is added in order to fit into the large opening in the fixed roof skin. This second closure element may be positioned adjacent the movable closure element in order to allow the use of a large interior opening.

Especially if the frame is substantially open at the position below the rear closure element and a extendable and retractable sunshade assembly is positioned substantially below the front and rear closure elements in their closed position, it is possible to selectively close off or open the entire roof opening which is only slightly smaller than the outer circumference of a standard (tilt) sliding roof frame.

The rear closure element is preferably a rigid transparent panel which is fixed in the trim ring, but it would also be possible to make the rear closure element movable (as a pop-up roof for example) or removable.

### BRIEF DESCRIPTION OF THE DRAWINGS

Further features and advantages of the invention will appear from the following description with reference to the drawings showing an exemplary embodiment of a roof assembly according to the invention.

FIG. 1 is a very schematic perspective view of the top part of a vehicle having an embodiment of the roof assembly according to the invention mounted in its fixed roof.

FIG. 2 is an exploded view of the main parts of the roof assembly of FIG. 1.

FIG. 3, 4 and 5 are enlarged sectional views according to the lines III-III, IV-IV and V-V, respectively in FIG. 1.

FIGS. 6 and 7 are even further enlarged sectional views according to the lines VI-VI and VII-VII, respectively in FIG. 1.

FIGS. 8 A-D are schematic longitudinal sectional views of the roof assembly of FIG. 1 in different positions, illustrating the operation of the sunshade assembly.

FIG. 9 is an enlarged perspective cut-out view of the retaining mechanism for the sunshade screen assembly of FIG. 8.

FIG. 10 is a view corresponding to that of FIG. 8 but showing only two parts thereof with one part partly cut away to illustrate the retaining mechanism.

FIGS. 11 A-E are plan views of the retaining mechanism of FIG. 9 in different positions to illustrate the operation of the retaining mechanism.

### DETAILED DESCRIPTION OF THE ILLSTRATIVE EMBODIMENT

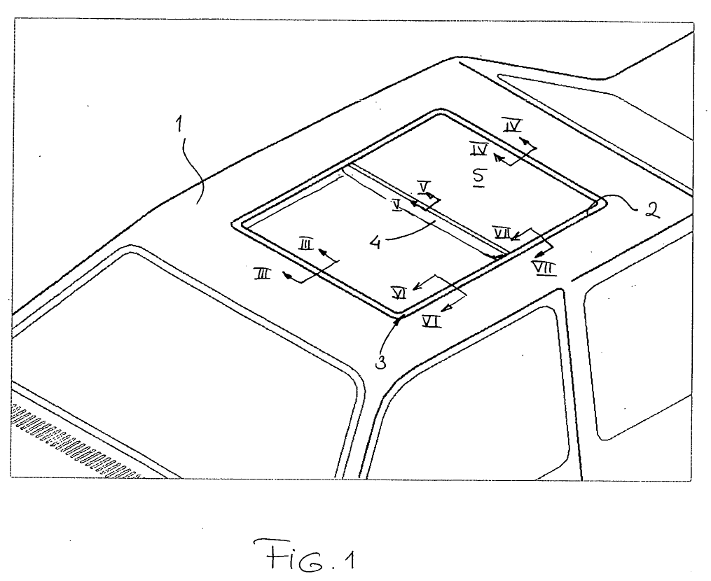

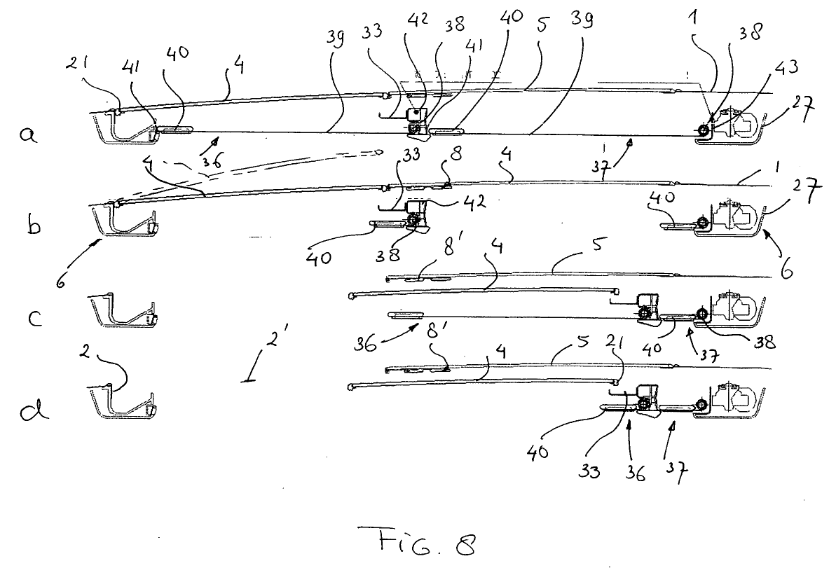

The drawings show an embodiment of the roof assembly according to the invention which is already built into a vehicle (in this case a passenger car) whose fixed roof skin 1 is provided with a large roof opening 2. The roof assembly comprises a frame 3 or other stationary part, which can be attached to the fixed roof skin 1. The frame 3 supports in a movable manner a first or front closure element 4. In the illustrated embodiment the closure element 4 is a rigid (transparent) panel, but may have other configurations or may include several parts. In this case, the front panel 4 operates as a so called tilt-sliding roof, wherein the panel 4 can be moved from the closed position (FIGS. 1 and 8a) in the roof opening 2 both to a venting position (dashed lines in FIG. 8b) in which it slopes upwardly, and to a downwardly moved and subsequently rearwardly slid open position (FIG. 8c).

In this open position, the panel 4 is moved underneath a second closure element 5, here also in the form of a rigid transparent panel, which in this case is a fixed panel. As an alternative, the panel 5 could be mounted in a detachable manner so that it is removable, or the panel 5 could be movable, for example as a pop-up panel which is tiltable to a venting position. Other arrangements are conceivable, while it is also possible to provide further panels or other types of closure elements.

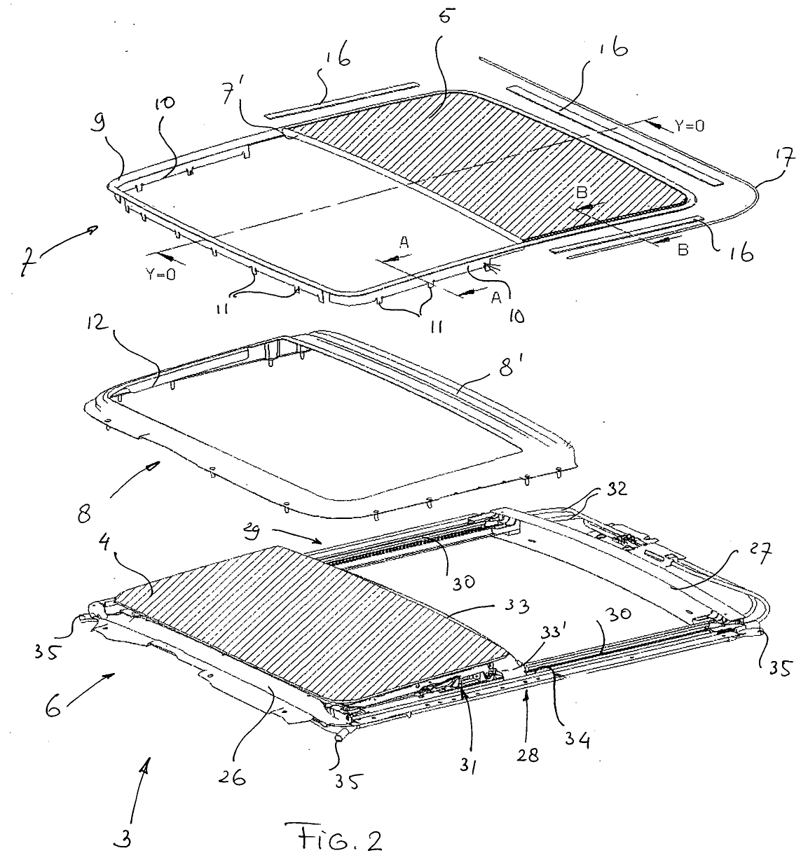

FIG. 2 shows the main parts of the roof assembly. The frame 3 of the roof has as its main components a main frame part 6, a trim ring 7 and a mounting frame 8. The trim ring 7 is intended to provide an accurate and smooth circumference for the roof opening 2 which is cut out in the roof skin 1. The trim ring 7 is mounted to the roof skin 1 from above. The mounting frame 8 is intended to form a fixture for the main frame part 6 in order to attach the main frame part 6 to the fixed roof skin 1 from below.

FIG. 3 and 4 show how the trim ring 7 is mounted to the fixed roof skin 1. FIGS. 2 and 3 show that a front portion of the trim ring 7 in front of a transverse part 7′ defines the actual passage opening and surrounds, together with the transverse part 7′, the front closure element 4 in its closed position. This front portion of the trim ring 7 does not only comprise a substantially horizontal flange 9, but also a substantially vertical flange 10 comprising a plurality of lips 11 distributed along the length of the flange 10. The flange 9 is adapted to engage the upper surface of the roof skin 1 in order to conceal the edge of the roof opening 2 and the lips 11 are intended to be folded about an inner vertical flange 12 of the mounting frame 8 in order to clamp the mounting frame 8 against the lower side of the fixed roof skin 1 and simultaneously clamp the horizontal flange 9 of the trim ring 7 against the upper side of the roof skin 1. In this manner both the trim ring 7 and the mounting frame 8 are fixed to the roof skin 1, the trim ring 7 from above, and the mounting frame 8 from below.

FIG. 4 shows that the trim ring 7 has a different cross section in the rear portion that surrounds the rear and sides of the rear panel 5. There, the trim ring 7 has, besides the flange 9, a substantially horizontal support flange 13 which is at a slightly lower level than the flange 9 and extending inwardly thereof, and further a substantially horizontal mounting flange 14 extending outwardly from a central part of the support flange 13 and forming a groove 15 between the mounting flange 14 and the support flange 13. The rear portion of the trim ring 7 is mounted to the fixed roof skin 1 by clamping the fixed roof skin 1 between the horizontal flange 9 and a clamping strip 16 with interposition of a clamping bead 17. The clamping strip 16 is slid into the groove 15 and the dimensions are such that the clamping bead 17 is urged against the lower side of the fixed roof skin 1 by the clamping strip 16 which fits into the mounting groove 15.

Because most flanges in the rear portion of the trim ring 7 are horizontal, the flexibility of the trim ring 7 in this rear portion is higher than that in the front portion that comprises the substantially vertical flange 10. As a result, the trim ring 7 can be easily bent within a vertical plane through the trim ring in its rear portion. As a result, the vertical shape of the trim ring 7 can be adapted to the curvature of the fixed roof skin 1, if necessary. Of course, especially in transverse direction (side-to-side of the vehicle), the roof skin 1 is also slightly flexible, so that the roof skin 1 may adapt itself to the shape of the trim ring 7 as well.

The glass panel 5 is fixed to the rear portion of the trim ring 7, so that this will add rigidity to the trim ring 7, but the glass panel 5 may bend slightly as well. The rear glass panel 5 is surrounded on three sides by a seal 18 which is solid. The glass panel 5 is fixed to the trim ring 7 by means of glue 19 or another adhesive which is provided in a shallow glue channel in the trim ring 7. The trim ring 7 is configured such that the upper surfaces of the glass panel 5, the seal 18 and the flange 9 are substantially flush with each other and project only very slightly above the roof skin 1, so that the presence of the roof assembly hardly affects the appearance of the vehicle.

The trim ring 7 comprises said central transverse part 7′ also to support the front side of the rear glass panel 5 illustrated in FIG. 5. It has a hollow structure and the front side provides a vertical sealing surface which may cooperate with a seal 21 about the circumference of the front panel 4 (see FIG. 8). The edges of the panels 4 and 5 are sharp at the sides facing each other in order to provide a substantially uninterrupted glass surface and obviate the need for a specially shaped intermediate part between the panels 4 and 5.

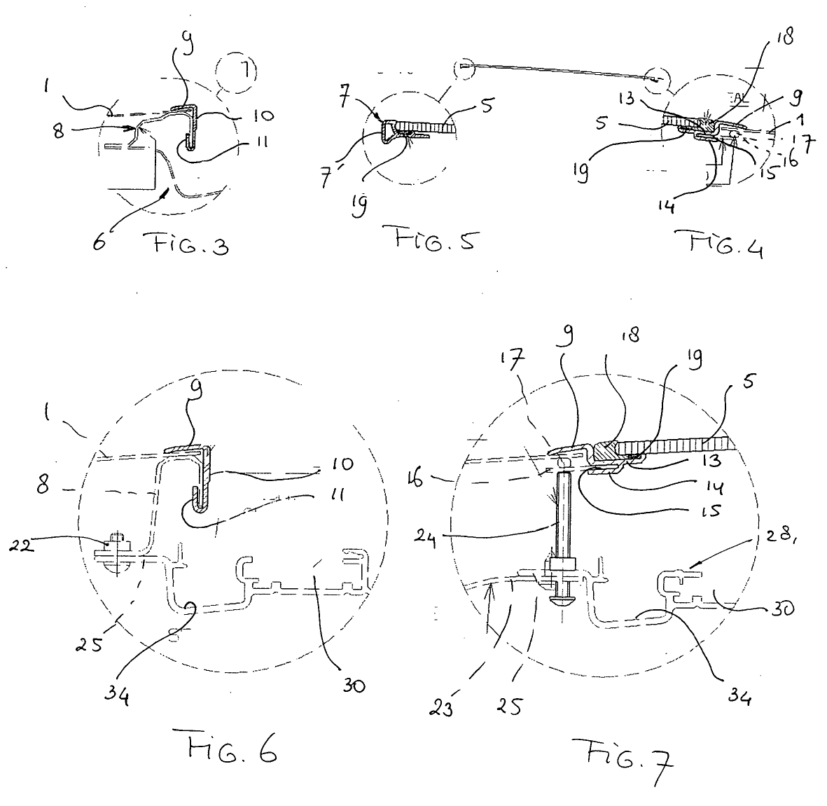

The mounting frame 8 as is shown in FIGS. 2, 3 and 6 includes fasteners, such as screws and nuts 22 in order to provide attachment of the front portion of the main frame part 6 to the mounting frame 8. The mounting frame 8 extends only around the opening that is closed by the front panel 4. A rear part 8′ of the mounting frame 8 extends below the panel 5 in the trim ring 7. The rear portion of the main frame part 6 is mounted directly to an adjacent side bracket 23 of the vehicle roof as is shown in FIG. 7. Adjustable screws 24 may be used to provide an extra support for the trim ring 7 by urging this adjusting screw 24 against the lower side of the clamping strip 16. This further supports the trim ring 7 in an adjustable manner so that the trim ring 7 may adapt itself to the shape of the roof skin 1 and still be supported by the main frame part 6 and a roof side bracket 23. The adjusting screws 24 are supported by a mounting flange 25 of the main frame part 6 and the side bracket 23.

The main frame part 6 is shown in FIGS. 2, 6 and 7 and includes a front transverse member 26, a rear transverse member 27 and two longitudinal side members 28 and 29. These longitudinal members 28 and 29 are substantially each others' mirror image. They carry or form longitudinal guide sections 30 which are used to guide closure operating mechanisms 31 movably supporting the front closure panel 4. In the exemplary embodiment, each closure operating mechanism 31 has parts to effect both the tilting movement of the panel 4 to the venting position and the sliding movement of the panel 4 between a front position within and below the roof opening and a rear position below the rear closure panel 5. The guide sections 30 guide the sliding movements of the parts of the closure operating mechanisms 31. An embodiment of this closure operating mechanism 31 is described in more detail in U.S. Pat. No. 5,531,501. The disclosure thereof is incorporated herein by reference thereto. The closure operating mechanism 31 per se does not form part of the invention.

Each closure operating mechanism 31 is driven by a drive cable 32 or other driving means which is actuated by a manual or electric drive, such as electric motor mounted to the rear transverse member 27 of the main frame part 6. The drive cable 32 is connected to a driven slide of the closure operating mechanism 31. The driven slide is operatively connected to a curve slide or other slide, which is stationary during vertical movements of the closure panel 4 and which moves with the closure panel 4 during sliding movements thereof. It therefore has a fixed horizontal relationship with the closure panel 4.

The closure operating mechanism 31 is coupled with a drain channel 33. This drain channel 33 is part of a water collecting and draining system of the roof assembly. The drain channel 33 is positioned under the rear edge of the closure panel 4 in forward positions of the closure panel 4 in order to receive and discharge any water dripping off from said rear edge or seeping pass the seal 21 of the closure panel 4 and the front of the transverse part 20 of the trim ring 7. The water received in the drain channel 33 is collected and discharged at its ends via a drain channel extension 33′ into lateral longitudinal stationary drain channels 34 equipped with drain pipes 35 to which tubes may be connected to discharge the collected water outside the vehicle.

As described, the transverse drain channel 33 follows the sliding movements of the closure panel 4 as is shown in FIG. 8.

FIG. 8 also illustrates the structure and operation of a sunshade assembly with which the interior opening in the vehicle roof and in the frame 3 may be opened and closed in order to selectively allow or stop light to enter the vehicle interior. In the embodiment shown use is made of an extendable and retractable sunshade assembly, in this case a front and rear screen assembly 36, 37, respectively.

Each screen assembly includes a winding mechanism 38, a flexible sunshade sheet 39, a grip part 40 at the free end of the flexible sheet 39 and a retaining mechanism 41 to be described later on. The winding mechanism 38 of the front screen assembly 36 is mounted through a screen assembly mount 42 to the transverse drain channel 33. The winding mechanism 38 of the rear screen assembly 37 is mounted to the rear transverse member 27 of the main frame part 6 through a screen assembly mount 43. The winding mechanism 38, and also the sheet 39 or the grip part 40 of the front screen assembly 36 cover the drain channel 33 from below. The front frame side retainer 44 of the retaining mechanism 41 on the front screen assembly 36 is connected to the slide of the closure operating mechanism 41 to which the drain channel 43 is connected as well. This means that if the front closure panel 4 makes a sliding movement, the slide of the operating mechanism 41 will slide and the drain channel 33 and the retainer part 44 will slide as well. This means that the screen assembly 36 will follow the sliding movements of the front closure panel 4 whether it is in the open or closed position.

The retainer part 44 of the rear screen assembly is connected to this slide of the front panel operating mechanism 31 as well, so that the grip part 40 of the rear screen assembly 36 will follow the sliding movements of the front closure panel 4 if the rear screen assembly 37 is in the “closed” position. Consequently, the rear screen assembly 36 will be opened and closed with the sliding movements of the closure panel 4. Of course, if the rear screen assembly 36 is already in the open position no movement of the rear screen assembly will take place.

FIG. 8 shows the operation of the screen assemblies 36 and 37. In FIG. 8A both screen assemblies 36 and 37 are in the closed position and also the closure panel 4 is in its closed position. In FIG. 8B, the rear screen assembly 37 is opened by moving the grip part 40 of the flexible sunshade sheet 39 rearwardly. Generally, the winding mechanism 38 will have a spring mechanism automatically winding the sunshade sheet when the grip part 40 is detached from the retainer 44 of the retaining mechanism 41.

In FIG. 8C, the closure panel 4 is moved downwardly and rearwardly to its open position below the fixed panel 5 and the front screen assembly 36 which was in its closed position according to FIG. 8A moves along with the front panel 4 so that only the front part of the roof opening is freed by the sun shade assembly.

In FIG. 8D, the front screen assembly 36 has been opened so that the roof opening is completely freed for light to enter the interior of the vehicle and for air to enter through the front roof opening. In this position, the grip part 40 of the rear screen assembly 37 might or might not be locked by the retainer 44 of the retaining mechanism 41 so that, if the front panel 4 is moved to its closed position again, the grip part 40 might or might not follow the movement thereof and consequently the rear screen assembly 37 might or might not be closed again.

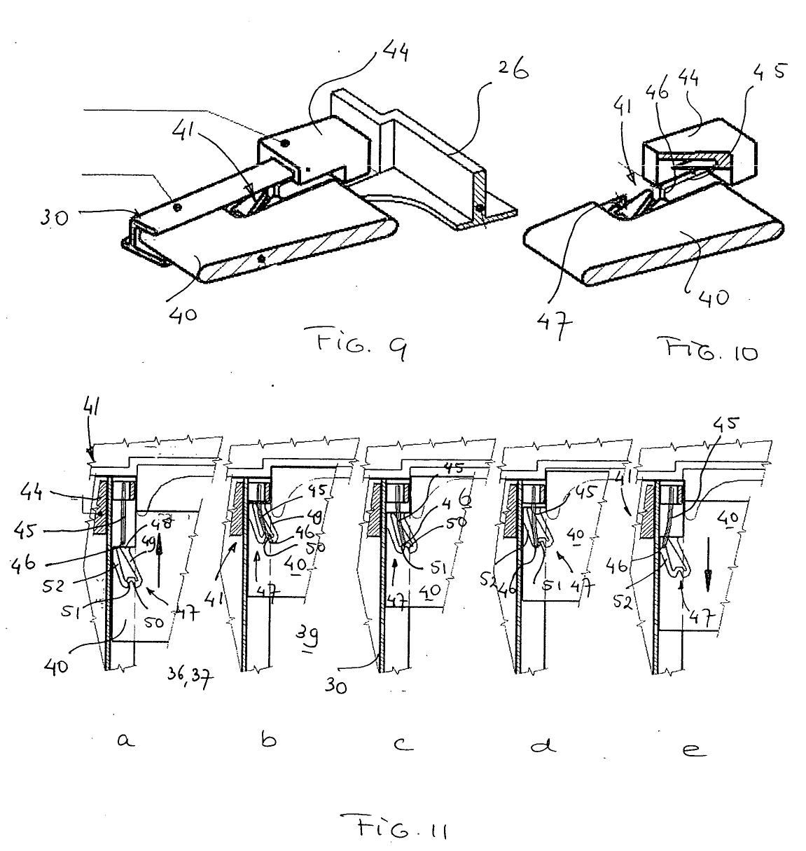

FIGS. 9, 10 and 11 show the retaining mechanism 41 of the front and rear screen assembly 36, 37. Such retaining mechanism 41 is provided in each longitudinal guide section 30 on both sides of the main frame part 6. The drawings show the grip part 40 on the front side of the flexible sheet 39 of the screen assemblies 36, 37, the front transverse member 26, the longitudinal guide section 30 on the left longitudinal member 28 of the main frame part 6 and the retainer 44 which is guided by the guide section 30 and is connected to the sliding part of the operating mechanism 41. The retaining mechanism 41 comprises a spring member 45 extending rearwardly in the retainer 44, being fixed on its front end and carrying a guide pin 46 or the like on its free rear end. In this embodiment the spring member 45 is a spring member which is able to flex in lateral direction.

The grip part 40 of the screen assembly 36, 37 has on its lateral ends a curved track 47 for cooperation with the guide pin 46 on the spring member 45. The curved track 47 has a first opening 48 in line with the guide pin 46 as seen in the direction of movement of the grip part 40. The curved track 47 has a first track portion 49 inclining rearwardly and inwardly, a short second track portion 50 inclining forwardly and outwardly, a short third track portion 51 inclining outwardly and rearwardly and a fourth track portion 52 inclined forwardly and outwardly.

The operation of the retaining mechanism 41 is explained with referenced to FIGS. 11 A-E.

In FIG. 11A the grip part 40 of the screen assembly 36, 37 arrives near its front position where it should be retained in order to close off the relevant roof opening that is covered by the flexible sunshade sheet 39. In this position, the guide pin 46 on the rear end of the spring member 45 of the retainer 44 is positioned in front of the opening 48 of the curved track 47.

FIG. 11B shows the grip part 40 in its most forward position in which the guide pin 46 has run through the first track portion 49 and has arrived at the end thereof, where the curved track 47 is sharply bent into the short second track portion 50. The spring member 45 is in a position in which it is bent inwardly so that the spring urges the guide pin 46 in an outward direction.

In FIG. 11C, the grip part 40 has been released and the grip part has been pulled back by the winding mechanism 38 of the respective screen assembly 36, 37. As a result, the grip part 40 has been moved back until the guide pin 46 stops a further rearward movement when it has been arrived at the transition between the short second and third track portions 50, 51. There the guide pin 46 has been caught in the cup-shaped track portion and as a result, the screen assembly is retained and locked in its closed position.

If a user wishes to open the screen assembly 36, 37 again, the grip part 40 is pushed forwardly again and FIG. 11D shows the situation after this short forward movement. As a result of the outward pressure on the guide pin 36 by the spring member 45, the guide pin 46 is urged into the third track portion 51 and the forward movement of the grip part 40 is stopped when the guide pin 46 has arrived at the transition between the third and fourth track portions 51, 52. In this position the spring member 45 is still bent slightly inwardly, so that a small outward spring force is still exerted on the guide pin 46.

FIG. 11E shows the position of the grip part 40 after it has been released and is pulled back slightly by its winding mechanism 38. Due to the spring force on the guide pin 46, it is urged into the fourth track portion 52 and the grip part 40 is no longer prevented from moving rearwardly. The guide pin 46 moves outwardly through the fourth track portion and is moved outwardly to such an extent that the spring member 45 is slightly bent outwardly at the time the guide pin 46 leaves the fourth track portion 52. When the guide pin 46 leaves the curved track 47, spring member 45 springs back to its central position according to FIG. 11A and the retaining mechanism 41 is ready again for a next retaining action.

The operation of the retaining mechanism 41 is comparable to that of a click mechanism of a ballpoint. It is simple and effective and operates in a reliable manner.

It will be apparent from the foregoing description that the invention provides a roof assembly which may have many components in common with a standard tilt-sliding roof but which has all the advantages of a panorama roof and is very well suited for aftermarket use and therefore may be fitted in many types of vehicles.

The invention is not limited to the embodiment shown in the drawing and described above and may be varied in different manners within the scope of the invention. For example, the sunshades may be formed as sunshades which are foldable in a zigzag manner.

1. A roof assembly for a vehicle having a roof opening in its fixed roof skin, comprising:
a frame which includes a trim ring having a passage opening and being adapted to be mounted in the roof opening in the roof skin from above, and a main frame part carrying longitudinal guide sections on either side of the roof opening and a drain channel assembly and drains to drain off any water collected in the drain channel assembly, said main frame part being adapted to be mounted to the fixed roof from below,
at least first and second closure elements, the second closure element being supported by the trim ring and being positioned behind the first closure element when the closure elements are in their closed position, the first closure element being moveable by means of said longitudinal guide sections at least between a closed position closing the passage opening and an open position in which it is slid under the second closure element and at least partially opening the passage opening.

2. The roof assembly of claim 1, wherein the frame is substantially open at a position below the rear closure element, and an extendible and retractable sunshade assembly is positioned substantially below the front and rear closure elements in their closed position.

3. The roof assembly of claim 1, wherein the rear closure element is a rigid transparent panel which is fixed in the trim ring.

4. The roof assembly of claim 2, wherein the extendable and retractable sunshade assembly comprises a screen assembly

5. The roof assembly of claim 4, wherein the screen assembly comprises at least two screen assemblies each positioned substantially below a respective closure element in their closed position, at least the front screen assembly being connected to a slide of an operating mechanism of the front closure element.

6. The roof assembly according to claim 5, wherein the screen assembly comprises a winding mechanism, a retaining mechanism at a distance from the winding mechanism, and a flexible sunshade sheet having one end connected to the winding mechanism and the opposite end connectable to the retaining mechanism, wherein both the winding mechanism and the retaining mechanism being mounted to the slide of the operating mechanism of the respective closure element.

7. The roof assembly of claim 6, wherein the retaining mechanism of the rear screen assembly is connected to the slide of the operating mechanism of the front closure element.

8. The roof assembly of claim 1, wherein the drain channel assembly comprises a transverse drain channel extending below a rear edge of the first closure element in the closed position thereof, the drain channel being connected to the slide of the operating mechanism and the front screen assembly being attached to the drain channel and covering it from below.

9. The roof assembly of claim 8, wherein the retaining mechanism of the rear screen assembly is connected to the drain channel.

10. The roof assembly of claim 1, wherein the frame further comprises a mounting frame between the trim ring and the main frame, the mounting frame being fixed to the roof skin through the trim ring and is fixed to the main frame through fasteners.

11. The roof assembly of claim 1, wherein the trim ring has a main plane, a front portion surrounding at least the front and sides of the first closure element and a rear portion surrounding at least the rear and sides of the second closure element, the flexibility of the rear portion, at least in a plane perpendicular to the main plane of the trim ring, is substantially higher than that of the front portion.

12. The roof assembly of claim 11, wherein the front portion of the trim ring comprises lips for fixing it to the roof skin, whereas the rear portion comprises a horizontal groove for co-operation with a fixing strip to fix the rear portion of the trim ring to the roof skin.

13. The roof assembly of claim 1, wherein the trim ring is provided with a flat flange as upper part of the trim ring adapted to engage the upper surface of the roof skin.

14. The roof assembly according to claim 1, comprising an operating mechanism for opening and closing said first closure element, and a driving member for driving said closure operating mechanism to open and close at least the first closure element.

15. A roof assembly for a vehicle having a roof opening in its fixed roof, comprising a stationary part including longitudinal guide sections on either side of the roof opening, at least two substantially transparent closure elements lying one behind the other in their closed position, at least the front closure element being slidable by means of a sliding mechanism, and an extendible and retractable sunshade assembly each positioned substantially below a respective closure element in their closed position, at least the front sunshade being connected to a sliding mechanism of the front closure element.

16. The roof assembly of claim 15, wherein the extendable and retractable sunshade assembly comprises a screen assembly.

17. The roof assembly of claim 16, wherein the screen assembly comprises at least two sunshade screen assemblies each positioned substantially below a respective closure element in their closed position, at least the front screen assembly being connected to the sliding mechanism of the front closure element.

18. The roof assembly according to claim 17, wherein the screen assembly comprises a winding mechanism, a retaining mechanism at a distance from the winding mechanism, and a sunshade sheet having one end connected to the winding mechanism and the opposite end connectable to the retaining mechanism, wherein both the winding mechanism and the retaining mechanism being mounted to the sliding mechanism of the respective closure element.

19. The roof assembly of claim 18, wherein the retaining mechanism of the rear screen assembly is connected to the sliding mechanism of the front closure element.

20. The roof assembly of claim 15, wherein the drain channel assembly comprises a transverse drain channel extending below a rear edge of the first closure element in the closed position thereof, the drain channel being connected to the sliding mechanism and the front screen assembly being attached to the drain channel and covering it from below.

21. The roof assembly of claim 20, wherein the retaining mechanism of the rear screen assembly is connected to the drain channel.

22. The roof assembly of claim 15, wherein the extendable and retractable sunshade includes a retaining mechanism having two detachable parts, one part of which is connected to a free end of the sunshade and the other part is connected to the frame, the parts acting as a ballpoint c lick-mechanism.

23. A roof assembly for a vehicle having a roof opening in its fixed roof, comprising a stationary part including longitudinal guide sections on either side of the roof opening, at least a substantially transparent closure element, and at least an extendible and retractable sunshade positioned substantially below the closure element in its closed position, wherein the extendable and retractable sunshade includes a retaining mechanism having two detachable parts, one part of which is connected to a free end of the sunshade and the other part is connected to the frame, the parts acting as a ballpoint click-mechanism.

24. The roof assembly of claim 23, wherein the extendable and retractable sunshade assembly is a screen assembly including a spring winding mechanism and a flexible sheet, one end of which is attached to the winding mechanism and the opposite end is provided with one of the detachable parts of the retaining mechanism.

25. The roof assembly of claim 23, wherein the retaining mechanism is provided in each of the longitudinal guide sections of the stationary part.
